(19) United States
(12) Patent Application Publication
(10) Pub. No.: US 2023/0107300 A1
(43) Pub. Date: Apr. 6, 2023

(54) FRACTURING MANIFOLD SKID AND FRACTURING MANIFOLD SKID SET

(71) Applicant: Yantai Jereh Petroleum Equipment & Technologies Co., Ltd., Yantai (CN)

(72) Inventors: Jinling HUANG, Yantai (CN); Siwu REN, Yantai (CN); Wenlong ZUO, Yantai (CN); Weixin LIN, Yantai (CN)

(73) Assignee: Yantai Jereh Petroleum Equipment & Technologies Co., Ltd., Yantai (CN)

(21) Appl. No.: 18/079,012

(22) Filed: Dec. 12, 2022

Related U.S. Application Data
(63) Continuation of application No. PCT/CN2021/127055, filed on Oct. 28, 2021.

(30) Foreign Application Priority Data
Nov. 23, 2020 (CN) 202022719104.1

(51) Int. Cl. E21B 43/26

(52) U.S. Cl. CPC E21B 43/2607

(57) ABSTRACT

A fracturing manifold skid and a fracturing manifold skid set are provided. The fracturing manifold skid includes a skid base assembly and a first manifold assembly. The first manifold assembly is installed on the skid base assembly and includes a first transport pipe and a second transport pipe, and a first connecting pipe and a second connecting pipe. The first connecting pipe is connected with the first transport pipe at a first position and connected with the second transport pipe at a second position; the second connecting pipe is connected with the first transport pipe at a third position and connected with the second transport pipe at a fourth position. The first transport pipe is provided with a first valve located between the first and third positions; the second transport pipe is provided with a second valve located between the second and fourth positions.

### CROSS-REFERENCE TO RELATED APPLICATIONS

The present application is a continuation of international patent application No. PCT/CN2021/127055 filed on Oct. 28, 2021, which claims the priority of Chinese patent application No. 202022719104.1 filed on Nov. 23, 2020, and the entire disclosure of these applications is incorporated herein by reference as part of the present application.

### TECHNICAL FIELD

Embodiments of the present disclosure relate to a fracturing manifold skid and a fracturing manifold skid set.

### BACKGROUND

After the production of an oil and gas well reaches a certain stage, the productivity and permeability decrease. In order to increase the oil and gas well production, fracturing technology can be adopted. At present, fracturing method has been widely used in oil and gas field development operation.

Fracturing can be divided into two categories: hydraulic fracturing and high-energy gas fracturing. Hydraulic fracturing is to inject fluid into the well at a high speed by the ground high-pressure pump truck set, and with the help of the high pressure held up at the bottom of the well, the rock in the oil and gas reservoir is cracked to produce cracks. In order to prevent the pressure dropping and the crack closing after the pump truck stops working, sand is mixed into the injected liquid after the formation of cracks, and enters the cracks together with the fluid, and stays in the cracks permanently, supporting the cracks to be open, so that the oil and gas flow environment can be improved for a long time. Hydraulic fracturing technology has obvious stimulation effect for oil and gas well, especially for oil and gas reservoir with low permeability.

### SUMMARY

Embodiments of the present disclosure provide a fracturing manifold skid and a fracturing manifold skid set. The fracturing manifold skid includes: a skid base assembly and the first manifold assembly. The first manifold assembly is installed on the skid base assembly and configured to transport fracturing fluid at a first pressure. The first manifold assembly includes a first transport pipe and a second transport pipe, and a first connecting pipe and a second connecting pipe. The first connecting pipe is connected to the first transport pipe at a first connecting position, and connected to the second transport pipe at a second connecting position, the second connecting pipe is connected to the first transport pipe at a third connecting position, and connected to the second transport pipe at a fourth connecting position. The first transport pipe is provided with a first valve which is located between the first connecting position and the third connecting position; the second transport pipe is provided with a second valve which is located between the second connecting position and the fourth connecting position. The first connecting pipe is provided with a third valve, and the second connecting pipe is provided with a fourth valve. The fracturing manifold skid can supply different kinds of fracturing fluid for different fracturing operation devices (such as fracturing pumps).

An embodiment of the disclosure provides a fracturing manifold skid including a skid base assembly and a first manifold assembly installed on the skid base assembly and configured to transport fracturing fluid at a first pressure. The first manifold assembly comprises a first transport pipe and a second transport pipe arranged side by side, and a first connecting pipe and a second connecting pipe arranged between the first transport pipe and the second transport pipe and communicating the first transport pipe and the second transport pipe, the first connecting pipe is connected to the first transport pipe at a first connecting position, and the first connecting pipe is connected to the second transport pipe at a second connecting position, the second connecting pipe is connected to the first transport pipe at a third connecting position, the second connecting pipe is connected to the second transport pipe at a fourth connecting position, and the first transport pipe is provided with a first valve which is located between the first connecting position and the third connecting position; the second transport pipe is provided with a second valve which is located between the second connecting position and the fourth connecting position; the first connecting pipe is provided with a third valve, and the second connecting pipe is provided with a fourth valve.

In some embodiments, the fracturing manifold skid further includes a second manifold assembly installed on the skid base assembly, the second manifold assembly comprises a main transport pipe configured to transport fracturing fluid in a length direction of the main transport pipe at a second pressure, the second pressure is greater than the first pressure, wherein the main transport pipe comprises at least one flanged straight pipe and a plurality of multi-interface pipe fittings connected with each other, each of the plurality of multi-interface pipe fittings comprises two main interfaces and at least one side interface, the two main interfaces and the at least one side interface are communicated with each other, at least part of the main interfaces are connected with the flanged straight pipe in the length direction by flanges, and an extension direction of each of the at least one side interface intersects with the length direction.

In some embodiments, the second manifold assembly further comprises a plurality of fifth valves, and the plurality of fifth valves are respectively connected with the side interfaces through flange union adapters.

In some embodiments, a diameter of the main transport pipe is not less than five and one eighth inches and a rated working pressure of the main transport pipe is not less than 103.5 MPa.

In some embodiments, the fifth valve is a plug valve or a one-way valve.

In some embodiments, the second manifold assembly is installed on the skid base assembly by U-shaped bolts.

In some embodiments, the fracturing manifold skid further includes a first fracturing head connected with a first end of the main transport pipe, wherein the first fracturing head comprises a plurality of fracturing head interfaces.

In some embodiments, the fracturing manifold skid further includes a blind flange connected to a second end of the main transport pipe, wherein the second end is opposite to the first end in the length direction.

In some embodiments, the fracturing manifold skid further includes a second fracturing head connected to a second end of the main transport pipe, wherein the second end is opposite to the first end in the length direction, and the second fracturing head comprises a plurality of fracturing head interfaces.

In some embodiments, the plurality of multi-interface pipe fittings comprise a flanged five-way joint and a plurality of flanged four-way joints, the first fracturing head is connected to the main interface of the flanged five-way joint, and the fracturing manifold skid further comprises a pressure detector and a safety valve connected to the side interfaces of the flanged five-way joint.

In some embodiments, a number of the plurality of multi-interface pipe fittings is greater than 2, and the first connecting pipe and the second connecting pipe are located between two of the plurality of multi-interface pipe fittings which are farthest away from each other in the length direction of the main transport pipe.

In some embodiments, at least one end of the first transport pipe and at least one end of the second transport pipe are provided with first interfaces, and sidewalls of the first transport pipe and the second transport pipe are respectively provided with a plurality of second interfaces.

In some embodiments, the first valve, the second valve, the third valve and the fourth valve are butterfly valves.

In some embodiments, the skid base assembly has at least one support leg provided with a height adjusting device configured to adjust a height of the at least one support leg.

An embodiment of the disclosure provides a fracturing manifold skid set including at least two fracturing manifold skids, wherein the first transport pipes of the first manifold assemblies of the at least two fracturing manifold skids are interconnected, and the second transport pipes of the first manifold assemblies of the at least two fracturing manifold skids are interconnected.

An embodiment of the disclosure provides a fracturing manifold skid set including at least two fracturing manifold skids, wherein the main transport pipes of the second manifold assemblies of the at least two fracturing manifold skids are interconnected, the first transport pipes of the first manifold assemblies of the at least two fracturing manifold skids are interconnected, and the second transport pipes of the first manifold assemblies of the at least two fracturing manifold skids are interconnected.

In some embodiments, the fracturing manifold skid set further includes a fracturing head and a blind flange, which are respectively connected to opposite ends of the connected main transport pipes.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic plane structure diagram of a fracturing manifold skid according to an embodiment of the present disclosure.

FIG. 2 is another schematic plane structure diagram of the fracturing manifold skid along a Z direction in FIG. 1.

FIG. 3 is a schematic simplified structural diagram of a first manifold assembly of a fracturing manifold skid according to an embodiment of the present disclosure.

FIG. 4 is another schematic simplified structural diagram of a first manifold assembly of a fracturing manifold skid according to an embodiment of the present disclosure.

FIG. 5 is a schematic plane structure diagram of a fracturing manifold skid set according to an embodiment of the present disclosure.

FIG. 6 is another schematic plane structure diagram of the fracturing manifold skid set along the Z direction in FIG. 5.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the invention. Based on the described embodiments herein, those skilled in the art can obtain other embodiment(s), without any inventive work, which should be within the scope of the disclosure.

Unless otherwise specified, the technical terms or scientific terms used in the disclosure shall have normal meanings understood by those skilled in the art. The words “first”, “second” and the like used in the disclosure do not indicate the sequence, the number or the importance but are only used for distinguishing different components. The word “comprise”, “include” or the like only indicates that an element or a component before the word contains elements or components listed after the word and equivalents thereof, not excluding other elements or components. The words “connection”, “connected” and the like are not limited to physical or mechanical connection but may include electrical connection, either directly or indirectly.

The fracturing manifold skid is an important device to connect the fracturing truck or the fracturing skid to the wellhead at the fracturing construction site, which usually includes a low-pressure manifold and/or a high-pressure manifold. The low-pressure manifold is used to supply low-pressure fracturing fluid to the fracturing pump on the fracturing truck, which is pressurized by the fracturing pump to form high-pressure fracturing fluid, the high-pressure fracturing fluid from multiple branches enters the high-pressure manifold and is then injected into oil and gas well. In the fracturing operation, the fracturing manifold skid can save the layout space of the well site, facilitate transportation, shorten the construction period and reduce the maintenance cost.

However, in fracturing operation, different construction processes raise different requirements for fracturing manifold skid. For example, in some cases, the low-pressure manifold of the fracturing manifold skid needs to provide different kinds of fracturing fluid for different fracturing trucks. For example, with the increase of oil and gas exploitation, there are more and more efficient fracturing construction methods such as “factory-style” fracturing and “zipper-style” fracturing. In addition, in order to improve the later production, the pressure of fracturing operation is getting higher and higher, and the flow rate of fracturing operation is also increasing. Therefore, the high-pressure manifold of fracturing manifold skid is required to have higher rated working pressure and larger flow rate.

An embodiment of the present disclosure provides a fracturing manifold skid and a fracturing manifold skid set. The fracturing manifold skid includes a skid base assembly and a first manifold assembly. The first manifold assembly is installed on the skid base assembly, and is configured to transport fracturing fluid at a first pressure. The first manifold assembly includes a first transport pipe and a second transport pipe, and a first connecting pipe and a second connecting pipe. The first connecting pipe is connected with the first transport pipe at a first connecting position and connected with the second transport pipe at a second connecting position; the second connecting pipe is connected with the first transport pipe at a third connecting position and connected with the second transport pipe at a fourth connecting position. The first transport pipe is provided with a first valve, which is located between the first connecting position and the third connecting position; the second transport pipe is provided with a second valve, which is located between the second connecting position and the fourth connecting position; the first connecting pipe is provided with a third valve, and the second connecting pipe is provided with a fourth valve. The fracturing manifold skid can supply different kinds of fracturing fluid for different fracturing operation devices (such as fracturing pumps).

Hereinafter, the fracturing manifold skid and the fracturing manifold skid set provided by the embodiments of the present disclosure will be described in detail with reference to the accompanying drawings.

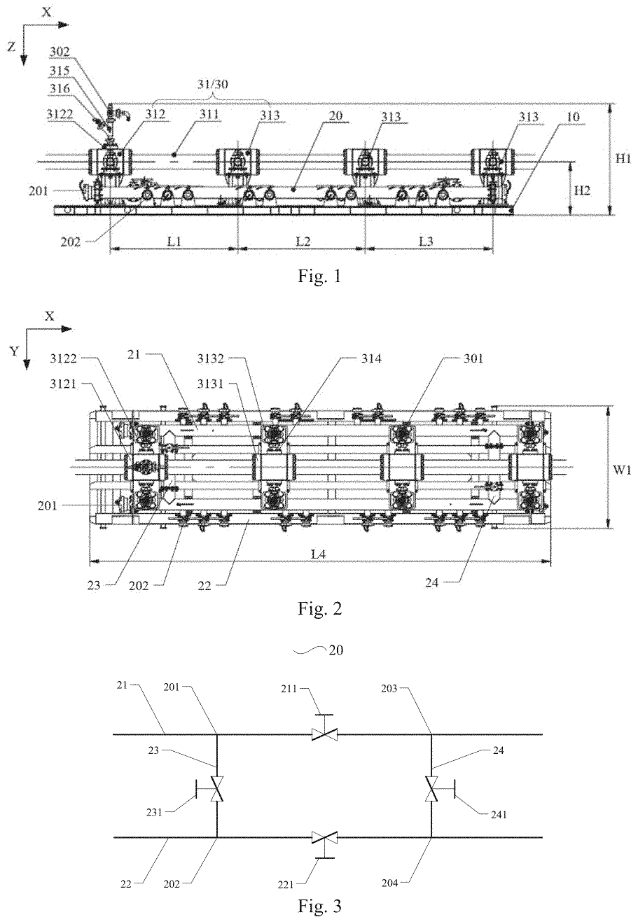

An embodiment of the present disclosure provides a fracturing manifold skid. FIG. 1 is a schematic plane structure diagram of a fracturing manifold skid according to an embodiment of the present disclosure, and FIG. 2 is another schematic plane structure diagram of the fracturing manifold skid shown in FIG. 1 along a Z direction. As illustrated by FIG. 1 and FIG. 2, the fracturing manifold skid includes a skid base assembly 10 and a first manifold assembly 20, and the first manifold assembly 20 is installed on the skid base assembly 10. The first manifold assembly 20 is configured to transport fracturing fluid at a first pressure. For example, in fracturing operation, a discharge port of the first manifold assembly 20 can be connected to a suction port of a fracturing pump to provide fracturing fluid for the fracturing pump.

FIG. 3 is a schematic simplified structural diagram of a first manifold assembly 20 of a fracturing manifold skid according to an embodiment of the present disclosure. As illustrated by FIG. 3, the first manifold assembly 20 includes a first transport pipe 21 and a second transport pipe 22 arranged side by side, and a first connecting pipe 23 and a second connecting pipe 24 arranged between the first transport pipe 21 and the second transport pipe 22 and communicating the first transport pipe 21 and the second transport pipe 22. The first connecting pipe 23 is connected to the first transport pipe 21 at a first connecting position 201 and connected to the second transport pipe 22 at a second connecting position 202. The second connecting pipe 24 is connected to the first transport pipe 21 at a third connecting position 203 and connected to the second transport pipe 22 at a fourth connecting position 204. The first transport pipe 21 is provided with a first valve 211, which is located between the first connecting position 201 and the third connecting position 203. The second transport pipe 22 is provided with a second valve 221, which is located between the second connecting position 202 and the fourth connecting position 204. The first connecting pipe 23 is provided with a third valve 231, and the second connecting pipe 24 is provided with a fourth valve 241.

By controlling the opening or closing of the first valve 211, the second valve 221, the third valve 231 and the fourth valve 241, the first manifold assembly 20 can realize different pipeline routes. For example, in a case that the first valve 211, the second valve 221, the third valve 231 and the fourth valve 241 are all opened, the first transport pipe 21, the second transport pipe 22, the first connecting pipe 23 and the second connecting pipe 24 communicate with each other, and the first manifold assembly 20 can transport a fracturing fluid. For example, in a case that the first valve 211 and the second valve 221 are opened, and the third valve 231 and the fourth valve 241 are closed, the first transport pipe 21 and the second transport pipe 22 form two mutually independent transport pipelines, which can be used for transporting different kinds of fracturing fluid, respectively. For example, in a case that the first valve 211 and the second valve 221 are closed and the third valve 231 and the fourth valve 241 are opened, the first transport pipe 21 on a left side of the first connecting position 201, the first connecting pipe 23 and the second transport pipe 22 on a left side of the second connecting position 202 form a transport path, and the first transport pipe 21 on a right side of the third connecting position 203, the second connecting pipe 24 and the second transport pipe 22 on a right side of the fourth connecting position 204 form another transport path, These two transport paths can also be used to transport different kinds of fracturing fluid, respectively.

It can be known from the above description that the fracturing manifold skid can provide different kinds of fracturing fluid for different fracturing operation devices (such as fracturing pumps) by controlling the opening or closing of the first valve 211, the second valve 221, the third valve 231 and the fourth valve 241.

For example, the first valve 211, the second valve 221, the third valve 231 and the fourth valve 241 may be butterfly valves.

It should be noted that FIG. 3 takes an example that the first transport pipe 21 and the second transport pipe 22 are arranged in parallel, and the first connecting pipe 23 and the second connecting pipe 24 are arranged perpendicular to the first transport pipe 21 and the second transport pipe 22. However, the structure of the first manifold assembly 20 is not limited thereto. For example, there may be a non-zero angle between the first transport pipe 21 and the second transport pipe 22; or, the first connecting pipe 23 and the second connecting pipe 24 may not be perpendicular to the first transport pipe 21 and the second transport pipe 22.

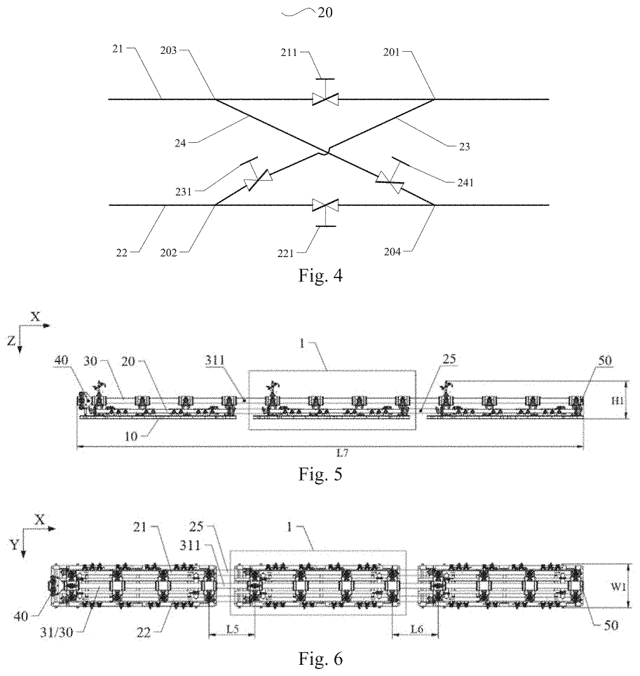

FIG. 4 is another simplified structural diagram of a first manifold assembly 20 of a fracturing manifold skid according to an embodiment of the present disclosure. As illustrated by FIG. 4, the first connecting pipe 23 and the second connecting pipe 24 may be arranged to cross each other, and they are not connected at the crossing position. This structure is similar to that illustrated by FIG. 3, and it can also provide different kinds of fracturing fluid for different fracturing operation devices (e.g., fracturing pumps) by controlling the opening or closing of the first valve 211, the second valve 221, the third valve 231 and the fourth valve 241, which will not be repeated here.

For example, inner diameters of the first transport pipe 21 and the second transport pipe 22, and the first connecting pipe 23 and the second connecting pipe 24 are 8 to 12 inches. Of course, the embodiments of the present disclosure are not limited thereto.

At least one end of the first transport pipe 21 and at least one end of the second transport pipe 22 are provided with first interfaces, and sidewalls of the first transport pipe 21 and the second transport pipe 22 are respectively provided with a plurality of second interfaces.

For example, as illustrated by FIGS. 1 and 2, the two ends of the first transport pipe 21 and the two ends of the second transport pipe 22 are provided with first interfaces 201, and the sidewalls of the first transport pipe 21 and the second transport pipe 22 are respectively provided with the plurality of second interfaces 202. The first interface is connected to an external fracturing fluid source to form a circulating fracturing fluid circuit. The second interface is connected to an external fracturing pump, and is used for supplying low-pressure fracturing fluid for the fracturing pump. For example, as illustrated by FIG. 2, the second interface 202 on the first transport pipe 21 is set towards an upper side, and the second interface 202 on the second transport pipe 22 is set towards an lower side to facilitate the connection of the fracturing pump.

For example, in addition to the first transport pipe 21 and the second transport pipe 22, the first manifold assembly may further include more transport pipes, which is not limited by the embodiment of the present disclosure.

For example, the skid base assembly 10 can be a base formed by welding a plurality of beams crossed with from each other, which serves to support various components on the fracturing manifold skid.

The fracturing manifold skid provided by the embodiments of the present disclosure can be used alone or in combination to supply different kinds of fracturing fluid for different fracturing operation devices (such as fracturing pumps).

An embodiment of the present disclosure provides a fracturing manifold skid set, which includes at least two fracturing manifold skids. The first transport pipes 21 of the first manifold assembly 20 of at least two fracturing manifold skids are connected to each other, and the second transport pipes 22 of the first manifold assembly 20 of at least two fracturing manifold skids are connected to each other. For example, the adjacent first transport pipes and the adjacent second transport pipes can be connected by a low-pressure hose. The fracturing manifold skid set can supply different kinds of fracturing fluid for different fracturing operation devices (such as fracturing pumps).

For example, as illustrated by FIG. 1 and FIG. 2, the fracturing manifold skid further includes a second manifold assembly 30, which is installed on the skid base assembly 10. The second manifold assembly 30 is configured to transport fracturing fluid at a second pressure in a length direction (X direction in the figure) of the main transport pipe, and the second pressure is greater than the first pressure. Therefore, the first manifold assembly 20 can also be called low-pressure manifold assembly, and the second manifold assembly 30 can also be called high-pressure manifold assembly. For example, the fracturing fluid transported by the first manifold assembly enters the suction port of the fracturing pump, and after being pressurized by the fracturing pump, the fracturing fluid is collected from the discharge port of the fracturing pump and enters the second manifold assembly, and the second manifold assembly transports the high-pressure fracturing fluid into the oil and gas well. For example, a rated working pressure of the second manifold assembly 30 can reach or exceed 103.5 MPa. The rated working pressure refers to a maximum allowable pressure inside the pipeline during work. For example, the rated working pressure of the second manifold assembly 30 can be 103.5 MPa, corresponding to the British Imperial unit for pressure of 15000 psi (pounds per square inch); or 140 MPa, corresponding to the British Imperial unit for pressure of 20000 psi.

For example, the second manifold assembly includes a main transport pipe, which includes at least one flanged straight pipe and a plurality of multi-interface pipe fittings connected to each other. Each of the plurality of multi-interface pipe fittings includes two main interfaces and at least one side interface, and the two main interfaces and at least one side interface communicate with each other, at least part of the main interfaces are connected with the flanged straight pipe by flanges in a length direction, and an extension direction of each of the at least one side intersects with the length direction (X direction). The main interface of the multi-interface pipe fitting is used for connecting the flanged straight pipe in the length direction of the main transport pipe to form the main transport pipe; part of the side interfaces are used to connect fracturing pumps and other equipment to input high-pressure fracturing fluid into the main transport pipe, and part of the side interfaces are used to connect safety valves and other functional components. The length direction of the main transport pipe is consistent with an extension direction of the flanged straight pipe.

For example, the multi-interface pipe fittings can be flanged three-way joint, flanged four-way joint or flanged five-way joint. The flanged three-way joint includes two main interfaces and one side interface, and the three interfaces are communicated with each other; the flanged four-way joint includes two main interfaces and two side interfaces, and the four interfaces are communicated with each other; the flanged five-way joint includes two main interfaces and three side interfaces, and the five interfaces are communicated with each other.

The following describes a structure of a second manifold assembly 30 with the fracturing manifold skid shown in FIGS. 1 and 2. FIGS. 1 and 2 illustrate that the main transport pipe 31 includes four multi-interface pipe fittings (three flange four-way joints and one flange five-way joint). It should be noted that FIG. 1 and FIG. 2 are only examples, and the embodiments of the present disclosure do not limit the types, numbers and relative positions of the multi-interface pipe fittings.

For example, as shown in FIGS. 1 and 2, the second manifold assembly 30 includes a main transport pipe 31, and the main transport pipe 31 includes three flanged straight pipes 311, a flanged five-way joint 312 and three flanged four-way joints 313 connected to each other. The flanged five-way joint 312 is located at one end of the main transport pipe 31, and all three flange four-way joints 313 are located at a same side of the flanged five-way 312, and one of the three flanged four-way joints 313 is located at another end of the main transport pipe 31. It is also possible that two flanged four-way joints 313 are located at two ends of the main transport pipe 31, and the flanged five-way joint 312 is located between the flange four-way joints 313 at two ends.

For example, four multi-interface pipe fittings can all be flanged five-way joints; or, the four multi-interface pipe fittings can include two flanged five-way joints and two flanged four-way joints; or, the four multi-interface pipe fittings can include three flanged five-way joints and one flanged four-way joint. For example, the four multi-interface pipe fittings can also be a combination of a flanged three-way joint and a flanged four-way joint, or a combination of a flanged three-way joint and a flanged five-way joint, or a combination of flanged three-way joint, a flanged four-way joint and a flanged five-way joint.

For example, the number of the multi-interface pipe fittings may be 2, 3 or more than 4, and this disclosure is not limited thereto.

As illustrated by FIG. 2, the flanged five-way joint 312 includes two main interfaces 3121 and three side interfaces 3122, and each flanged four-way joint 313 includes two main interfaces 3131 and two side interfaces 3132. Each main interface and each side interface are flanged interfaces.

Each main interface of the flanged five-way joint 312 and the flanged four-way joint 313 is arranged in the length direction (X direction) of the main transport pipe 31, and the main interfaces of the flanged five-way joint 312 and the flanged four-way joint 313 are connected to the flanged straight pipe 311 by flanges.

Compared with union connection, flange connection is used for the main transport pipe, which is beneficial to increasing the diameter of the main transport pipe and improving the tightness of the connecting position. For the pipeline connection with smaller diameter, union connection is usually used in oil fields and tightened by hammering. With the increasing of pipeline diameter (for example, more than 4 inches), the tightening force required for union connection also increases, which is very unfavorable to workers' operation. However, the flange connection greatly reduces the tightening force, so a larger diameter transport pipe can be used to increase the flow rate of the second manifold assembly. For example, in the embodiment of the present disclosure, the flow rate of the main transport pipe can replace the flow rate of six conventional high-pressure manifolds in the traditional well site.

For example, inner diameters of the main interfaces of the flanged five-way joint and the flanged four-way joint arranged in the length direction (parallel to the X direction) of the main transport pipe 31 and the flanged straight pipe are all not less than five and one eighth inches, that is to say, the diameter of the main transport pipe 31 is not less than five and one eighth inches. For example, the diameter range of the main transport pipe 31 can reach 8 inches. Of course, the embodiments of the present disclosure are not limited thereto.

For example, as illustrated by FIGS. 1 and 2, one side interface of the flanged five-way joint 312 is arranged in the −Z direction, and the other two side interfaces of the flanged five-way joint 312 are respectively arranged in the Y direction and the −Y direction. Two side interfaces of each flanged four-way joint 313 are respectively arranged in the Y direction and the −Y direction. Each side interface of the flanged five-way joint 312 and the flanged four-way joint 313 is connected to a flange union adapter 314.

Two ends of the flange union adapter 314 are a flange joint and a union joint, respectively. The flange joint is connected to the side interface of the flanged four-way joint or flanged five-way joint, and the union joint is used for connecting valves or other components.

For example, as illustrated by FIG. 1, the side interface of the flanged five-way joint 312 facing the −Z direction is connected to the flange joint of the flange union adapter 314, and the union joint of the flange union adapter 314 is connected to a different shaped three-way joint 315. The main interface of the different shaped three-way joint 315 facing the −Z direction is provided with a safety valve 302, and the side interface of the different shaped three-way joint 315 is provided with a pressure detector 316, such as a pressure transmitter. The pressure detector 316 can monitor a pressure at this location. The safety valve 302 is used to provide overpressure protection. For example, the safety valve 302 can be a mechanical pressure relief valve. In a case that the pressure is greater than a set safety threshold, the safety valve 302 can automatically be opened to relieve the pressure in time, thus improving the safety of the operation site.

For example, as illustrated by FIGS. 1 and 2, the second manifold assembly 30 further includes a plurality of fifth valves 301, and the plurality of fifth valves 301 are respectively connected to the side interface 3122 of the flanged five-way joint and the side interfaces 3132 of the flanged four-way joints through the flange union adapters 314.

For example, as illustrated by FIGS. 1 and 2, except for the side interface of the flanged five-way joint 312 arranged in the −Z direction, the other side interfaces are connected to one end of the fifth valve 301 through the flange union adapter 314 in one-to-one correspondence. For example, the fifth valve 301 can be a plug valve or a one-way valve, and its interface connected with an external end is a union interface, which makes field connection and maintenance more convenient. The fifth valve can control an opening and closing of the pipeline, so as to provide safety guarantee for the operation and maintenance of the fracturing pump in the working gap.

For example, for the second manifold assembly shown in FIGS. 1 and 2, which includes three flanged four-way joints 313, and can be connected with eight fifth valves 301. The number of the fifth valves can be increased or decreased by adjusting the number and/or types of multi-interface pipe fittings. Another end of each fifth valve is provided with a union joint, which can be used to connect the discharge port of the fracturing pump.

In the second manifold assembly 30, eight fifth valves can be used as input ports of high-pressure fracturing fluid, and the high-pressure fracturing fluid generated by the fracturing pump is fed into the main transport pipe 31.

For example, the second manifold assembly 30 is installed on the beam of the skid base assembly by U-shaped bolts. By loosening the U-shaped bolts, an installation position of the second manifold assembly on the skid base assembly along the X direction or the Y direction can be conveniently adjusted, which improves the flexibility of the installation of the second manifold assembly.

As illustrated by FIGS. 1 and 2, in the fracturing manifold skid including three flanged four-way joints 313 and three flanged straight pipes 311, distances between adjacent flanged four-way joint 313 and flanged five-way joint 312 and between adjacent flanged four-way joints 313 are L1, L2 and L3, respectively. For example, L1, L2 and L3 can be equal, all about 2500 mm A maximum length of the fracturing manifold skid (along the X direction) is L4. For example, L4 may be about 9000 mm A maximum height of the fracturing manifold skid (along Z direction) is HE For example, H1 may be about 2190 mm A distance between the main transport pipe 31 and a bottom of the skid base assembly 10 is H2. For example, H2 may be about 1045 mm A maximum width of the fracturing manifold skid (along the Y direction) is W1. For example, W1 may be about 2390 mm.

It should be noted that the above dimensions are only an example and can be modified according to specific circumstances, and the embodiments of the present disclosure are not limited thereto.

In the fracturing manifold skid provided by the embodiment of the present disclosure, a main passage of the main transport pipe is connected by a flange, and a side passage is connected by a union. By combining flange and union connection in the main transport pipe, it not only has the effect of reliable and convenient installation, but also can provide higher flow rate of high-pressure fracturing fluid. By integrating the first manifold assembly and/or the second manifold assembly onto the skid base assembly, it is convenient to transport the fracturing manifold skid and adjust the placement position on site.

In the fracturing manifold skid provided by the embodiment of the present disclosure, the upper and lower relative positions of the first manifold assembly and the second manifold assembly are not limited, that is to say, the second manifold assembly is at the upper position, and the first manifold assembly is at the lower position, or vice versa.

For example, in the second manifold assembly, the number of the main transport pipes 31 may be multiple, and a plurality of main transport pipes may be connected by connecting pipes, and the connecting structure may refer to the connecting structure of the first manifold assembly. The embodiment of the present disclosure is not limited thereto.

The fracturing manifold skid provided by the embodiment of the present disclosure can be independently used in oil and gas field fracturing construction site to provide high-pressure fracturing fluid for oil and gas well.

For example, one end of the main transport pipe 31 is connected with a first fracturing head (not shown in FIGS. 1 and 2, please refer to the fracturing head in later FIGS. 5 and 6), which is connected with a first end of the main transport pipe 31, that is to say, connected with the main interface at the end of flanged five-way joint (a leftmost main interface in FIG. 1). The first fracturing head is used to transport the fracturing fluid in the main transport pipe 31 to the oil and gas well.

For example, the other end of the main transport pipe 31 is connected to a blind flange (not shown in the figure), which is connected to a second end of the main transport pipe 31, i.e., the main interface at a right end of the rightmost flanged four-way joint 313, for plugging the end of the main transport pipe. The second end is opposite to the first end in the length direction (X direction). The first fracturing head comprises a plurality of fracturing head interfaces, and high-pressure fracturing fluid is injected into the oil and gas well through the first fracturing head. For example, a split manifold skid may be arranged between the first fracturing head and the oil and gas well, and the fracturing fluid may be injected into the same oil and gas well or multiple oil and gas wells through the split manifold skid, which is not limited by the embodiment of the present disclosure.

For example, the other end of the main transport pipe can be connected with a second fracturing head (not shown in FIGS. 1 and 2, please refer to the fracturing head in later FIGS. 5 and 6), and connected with the second end of the main transport pipe 31, which does not need to be connected with the blind flange in this case. The structure of the second fracturing head can be the same as that of the first fracturing head and include multiple fracturing head interfaces. The interface of the second fracturing head can be connected to the discharge port of the fracturing pump, which is used to increase the number of fracturing pumps, thereby increasing the flow rate of the main transport pipe.

For example, as illustrated by FIGS. 1 and 2, in the length direction of the main transport pipe 31, the first connecting pipe 23 and the second connecting pipe 24 are located between the flanged five-way joint 312 and the flanged four-way joint 313, which are respectively arranged at two ends of the main transport pipe with the maximum distance. It can be understood that the number of the flanged four-way joint and the flanged five-way joint is not limited here. For example, in a case that the number of the multi-interface pipe fittings is greater than 2, the first connecting pipe 24 and the second connecting pipe 25 are located between the two of the multi-interface pipe fittings with the maximum distance in the length direction of the main transport pipe.

For example, the skid base assembly 10 may include a plurality of support legs, at least one of the support legs is provided with a height adjusting device configured to adjust a height of the at least one of the support legs. The height adjusting device can be realized by various structures, for example, the height can be adjusted by screw thread, chute and fastening structure, hydraulic system, gear rack structure, or four-bar linkage. The embodiment of this disclosure will not be described in detail. By setting the height adjusting device, in a case that the ground on the operation site is uneven, the heights of different support legs can be adjusted, thus improving the environmental adaptability of the fracturing manifold skid.

The fracturing manifold skid provided by the embodiment of this disclosure can also be combined and used in oil and gas field fracturing operation sites to form a fracturing manifold skid set, so as to connect more fracturing trucks, thereby improving the flow rate of the main transport pipe.

An embodiment of this disclosure provides a fracturing manifold skid set, which includes at least two fracturing manifold skids provided in any of the above embodiments, the main transport pipes of the second manifold assemblies of at least two fracturing manifold skids are interconnected, the first transport pipes of the first manifold assemblies of at least two fracturing manifold skids are interconnected, and the second transport pipes of the first manifold assemblies of at least two fracturing manifold skids are interconnected.

FIG. 5 is a schematic plane structure diagram of a fracturing manifold skid set according to an embodiment of the present disclosure, and FIG. 6 is another schematic plane structure diagram of the fracturing manifold skid set along the Z direction in FIG. 5. FIGS. 5 and 6 illustrate that the fracturing manifold skid set includes three fracturing manifold skids, but the embodiment of this disclosure is not limited thereto.

As illustrated by FIGS. 5 and 6, the fracturing manifold skid set includes three fracturing manifold skids 1, the main transport pipes 31 of the second manifold assemblies 30 of the three fracturing manifold skids 1 are connected to each other, the first transport pipes 21 of the first manifold assemblies 20 of the three fracturing manifold skids 1 are connected to each other, the second transport pipes 22 the first manifold assemblies 20 of the three fracturing manifold skids 1 are connected to each other. For example, adjacent main transport pipes can be connected by flanged straight pipes 311, and adjacent first transport pipes 21 and adjacent second transport pipes 22 can be connected by low-pressure hoses 25.

Through the combined use of multiple fracturing manifold skids, the number of fracturing trucks that can be connected is further increased, thus increasing the flow rate of the main transport pipe.

For example, as illustrated by FIGS. 5 and 6, the fracturing manifold skid set further includes a fracturing head 40 and a blind flange 50, which are connected to opposite ends of the connected main transport pipes 31, respectively. The fracturing head 40 is used for connecting oil and gas well, and the blind flange 50 is used for plugging one end of the second manifold assembly. The fracturing head 40 may include the same structure as the aforementioned first fracturing head and the aforementioned second fracturing head. The blind flange 50 may include the same structure as the aforementioned blind flange.

For example, the fracturing head 40 can also be replaced by a single-pipe universal structure, which can also be connected to the wellhead.

For example, in the fracturing manifold skid set, the side interface 3122 facing the −Z direction of the flanged five-way joint 312 near the fracturing head 40 can be used as a pressure monitoring port to connect the pressure detector 316 and the safety valve 302. The other two side interfaces 3122 facing the −Z direction of the flanged five-way joint 312 can be used as fracturing fluid input ports and connected with the discharge ports of fracturing pumps.

As illustrated by FIGS. 5 and 6, in the fracturing manifold skid set with three fracturing manifold skids 1, a distance between adjacent fracturing manifold skids 1 (a distance between centers of the flanged four-way joint and the flanged five-way joint which are close to each other in adjacent fracturing manifold skids 1) is L5 and L6, respectively. For example, L5 and L6 can be equal to each other, both of which are about 2500 mm, it can also be 1900 mm or 3300 mm, etc. A maximum length of the fracturing manifold skid set (along the X direction) is L7. For example, L7 may be about 29,193 mm. The above dimensions are only an example, and can be modified according to specific situations, and the embodiments of the present disclosure are not limited thereto.

For example, the skid base assembly of the fracturing manifold skid set may include a plurality of support legs, at least one of the support legs is provided with a height adjusting device configured to adjust a height of at least one support leg. By setting the height adjusting device, in a case that the ground on the operation site is uneven, the heights of different support legs can be adjusted, thus improving the environmental adaptability of the fracturing manifold skid.

The fracturing manifold skid set provided by the embodiment of the present disclosure can further improve the flow rate of the main transport pipe. In addition, it can be disassembled into multiple fracturing manifold skids for easy transportation.

The following points should be noted:

(1) Only the structures relevant to the embodiments of the present invention are involved in the accompanying drawings of the embodiments of the present invention, and other structures may refer to the conventional design.

(2) The embodiments of the present invention and the features in the embodiments may be mutually combined without conflict.

The foregoing is only the preferred embodiments of the present disclosure and not intended to limit the scope of protection of the present disclosure. Any change or replacement that may be easily thought of by those skilled in the art within the technical scope disclosed by the present disclosure shall fall within the scope of protection of the present disclosure. Therefore, the scope of protection of the present invention shall be defined by the appended claims.

What is claimed is:

1. A fracturing manifold skid, comprising:
a skid base assembly; and
a first manifold assembly installed on the skid base assembly and configured to transport fracturing fluid at a first pressure.
wherein the first manifold assembly comprises a first transport pipe and a second transport pipe arranged side by side, and a first connecting pipe and a second connecting pipe arranged between the first transport pipe and the second transport pipe and communicating the first transport pipe and the second transport pipe, the first connecting pipe is connected to the first transport pipe at a first connecting position, and the first connecting pipe is connected to the second transport pipe at a second connecting position, the second connecting pipe is connected to the first transport pipe at a third connecting position, the second connecting pipe is connected to the second transport pipe at a fourth connecting position, and the first transport pipe is provided with a first valve which is located between the first connecting position and the third connecting position; the second transport pipe is provided with a second valve which is located between the second connecting position and the fourth connecting position; the first connecting pipe is provided with a third valve, and the second connecting pipe is provided with a fourth valve.

2. The fracturing manifold skid according to claim 1, wherein the fracturing manifold skid further comprises a second manifold assembly installed on the skid base assembly, the second manifold assembly comprises a main transport pipe configured to transport fracturing fluid in a length direction of the main transport pipe at a second pressure, the second pressure is greater than the first pressure,
wherein the main transport pipe comprises at least one flanged straight pipe and a plurality of multi-interface pipe fittings connected with each other, each of the plurality of multi-interface pipe fittings comprises two main interfaces and at least one side interface, the two main interfaces and the at least one side interface are communicated with each other, at least part of the main interfaces are connected with the flanged straight pipe in the length direction by flanges, and an extension direction of each of the at least one side interface intersects with the length direction.

3. The fracturing manifold skid according to claim 2, wherein the second manifold assembly further comprises a plurality of fifth valves, and the plurality of fifth valves are respectively connected with the side interfaces through flange union adapters.

4. The fracturing manifold skid according to claim 2, wherein a diameter of the main transport pipe is not less than five and one eighth inches and a rated working pressure of the main transport pipe is not less than 103.5 MPa.

5. The fracturing manifold skid according to claim 3, wherein the fifth valve is a plug valve or a one-way valve.

6. The fracturing manifold skid according to claim 2, wherein the second manifold assembly is installed on the skid base assembly by U-shaped bolts.

7. The fracturing manifold skid according to claim 2, further comprising a first fracturing head connected with a first end of the main transport pipe, wherein the first fracturing head comprises a plurality of fracturing head interfaces.

8. The fracturing manifold skid according to claim 7, further comprising a blind flange connected to a second end of the main transport pipe, wherein the second end is opposite to the first end in the length direction.

9. The fracturing manifold skid according to claim 7, further comprising a second fracturing head connected to a second end of the main transport pipe, wherein the second end is opposite to the first end in the length direction, and the second fracturing head comprises a plurality of fracturing head interfaces.

10. The fracturing manifold skid according to claim 7, wherein the plurality of multi-interface pipe fittings comprise a flanged five-way joint and a plurality of flanged four-way joints, the first fracturing head is connected to the main interface of the flanged five-way joint, and the fracturing manifold skid further comprises a pressure detector and a safety valve connected to the side interfaces of the flanged five-way joint.

11. The fracturing manifold skid according to claim 2, wherein a number of the plurality of multi-interface pipe fittings is greater than 2, and the first connecting pipe and the second connecting pipe are located between two of the plurality of multi-interface pipe fittings which are farthest away from each other in the length direction of the main transport pipe.

12. The fracturing manifold skid according to claim 1, wherein at least one end of the first transport pipe and at least one end of the second transport pipe are provided with first interfaces, and sidewalls of the first transport pipe and the second transport pipe are respectively provided with a plurality of second interfaces.

13. The fracturing manifold skid according to claim 1, wherein the first valve, the second valve, the third valve and the fourth valve are butterfly valves.

14. The fracturing manifold skid according to claim 1, wherein the skid base assembly has at least one support leg provided with a height adjusting device configured to adjust a height of the at least one support leg.

15. A fracturing manifold skid set, comprising at least two fracturing manifold skids according to claim 1, wherein the first transport pipes of the first manifold assemblies of the at least two fracturing manifold skids are interconnected, and the second transport pipes of the first manifold assemblies of the at least two fracturing manifold skids are interconnected.

16. A fracturing manifold skid set, comprising at least two fracturing manifold skids according to claim 2, wherein the main transport pipes of the second manifold assemblies of the at least two fracturing manifold skids are interconnected, the first transport pipes of the first manifold assemblies of the at least two fracturing manifold skids are interconnected, and the second transport pipes of the first manifold assemblies of the at least two fracturing manifold skids are interconnected.

17. The fracturing manifold skid set according to claim 16, further comprising a fracturing head and a blind flange, which are respectively connected to opposite ends of the connected main transport pipes.
